(19) United States
(12) Patent Application Publication
(10) Pub. No.: US 2018/0066367 A1
(43) Pub. Date: Mar. 8, 2018

(54) METHOD FOR PRODUCING A CORROSION PROTECTION LAYER FOR THERMAL INSULATION LAYERS MADE OF HOLLOW ALUMINUM OXIDE BALLS AND GLASS LAYER AS OUTER LAYER AND COMPONENT

(71) Applicant: Siemens Aktiengesellschaft, München (DE)

(72) Inventors: Mathias Galetz, Frankfurt (DE); Xabier Montero, Frankfurt (DE); Alexander Rötzheim, Mülheim/Ruhr (DE); Werner Stamm, Mülheim an der Ruhr (DE)

(21) Appl. No.: 15/560,306

(22) PCT Filed: Apr. 4, 2016
(86) PCT No.: PCT/EP2016/057309

§ 371 Date: Sep. 21, 2017

(30) Foreign Application Priority Data
Apr. 9, 2015 (DE) 10 2015 206 332.1

(51) Int. Cl. C23C 28/00

(52) U.S. Cl. CPC C23C 28/3215; C01F 7/02; C23C 28/347; C23C 28/3455

(57) ABSTRACT

The joining of hollow aluminum oxide particles and an outer glass layer which is produced, in particular, by means of a heat treatment gives particular corrosion protection for ceramic thermal barrier coatings. Disclosed is a special type of corrosion protection for ceramic thermal insulation layers which is produced by joining hollow aluminum oxide particles and an outer glass layer, which is produced in particular by thermal treatment.

### CROSS-REFERENCE TO RELATED APPLICATIONS

This application claims priority to PCT Application No. PCT/EP2016/057309, having a filing date of Apr. 4, 2016, based off of German application No. 102015206332.1 having a filing date of Apr. 9, 2015, the entire contents of both of which are hereby incorporated by reference.

### FIELD OF TECHNOLOGY

The following relates to protection of a thermal barrier coating against corrosion, which comprises hollow aluminum oxide spheres and can further comprise a vitreous outer protective layer.

### BACKGROUND

Components which are coated with thermal barrier coatings composed of partially stabilized zirconia or gadolinium zirconate to lower the metal temperature are present in the hot gas path. The present-day surface temperatures of the ceramics in combination with impurities such as CMAS lead to chemical attacks on the ceramics and also to intrusion of liquid phases into the pores of the ceramic. At the same time, abrasion of compressor abradables can lead to one-off nickel coatings on the layers. This also leads to TBC spalling as a result of reduced thermal expansion. There has hitherto been no system which is stable in the long term against this multiple attack.

### SUMMARY

An aspect relates to solving the abovementioned problem.

### BRIEF DESCRIPTION

Further advantageous measures which can be combined with one another in any way in order to achieve further advantages are listed in the dependent claims. Some of the embodiments will be described in detail, with reference to the following figures, wherein like designations denote like members, wherein:

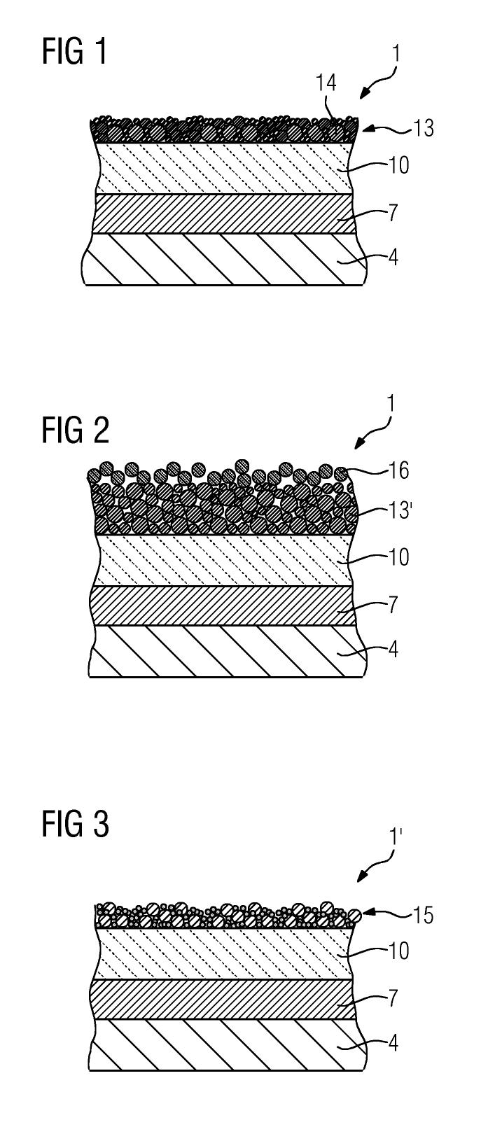

FIGS. 1, 2, 3 schematically show layer systems according to embodiments of the invention having a corrosion protection layer.

### DETAILED DESCRIPTION

The drawing and the description present only illustrative embodiments of the invention.

The inventive step lies in the application of a layer composed of aluminum particles, in particular by means of a slip.

A second optional layer has the composition of a low-melting, viscous glass whose melting point is preferably lower than or in the region of the melting point of the diffusing metal in the underlying layer. The glass comprises, in particular, substantially SiO₂ and preferably contains accompanying elements relevant for setting the melting point, e.g. magnesium (Mg), calcium (Ca) or else boron (B) and/or sodium (Na).

The glass can also be formed only during the heat treatment in an oxygen-containing atmosphere from a silazane, siloxane or silicone polymer as precursor. These precursors can contain inorganic fillers to adjust the shrinkage and degradation behavior and resistance to CMAS attack.

In any case, the additional layer of the glass can bring about oxidation of the aluminum particles without pure aluminum particles running along the surface of the system blocking holes of the component during aging.

FIG. 1 shows a layer system 1 according to embodiments of the invention which has a substrate 4.

The substrate 4 is, in particular, metallic and comprises, in particular, a nickel- or cobalt-based superalloy.

An optional metallic bonding layer 7 is present on the substrate 4. In particular, this is a coating layer based on, in particular, MCrAlY (M=Ni, Co and/or Fe).

An oxide layer (TGO), which is not described in more detail here, is formed on this bonding layer 7 during the further coating operation, or by deliberate oxidation or at least during operation.

A ceramic protective layer 10 is present on this thermally grown oxide layer (TGO) or on the metallic bonding layer. This protective layer 10 can comprise single-layer zirconium oxide or two-layer zirconium oxide and pyrochlore or “DVC” layers.

According to embodiments of the invention, a corrosion protection layer 13 composed of aluminum oxide spheres 14 is present on the ceramic protective layer 10 (FIG. 1), but with a viscous glass having optionally been applied as outer layer 16 (FIG. 2).

To carry out production, a layer of aluminum particles, in particular having particle sizes of from 1 μm to 50 μm is applied on top of the ceramic protective layer 10, in particular by means of a slip, vapor deposition, sputtering, etc. This layer can have a layer thickness in the range from a few microns to 300 μm in particular not more than 200 μm very particularly not more than 100 μm.

This layer is intended to prevent intrusion of the CMAS (CMAF) layer and react with the CMAS (CMAF). Aluminum oxide and a reaction layer are formed between thermal barrier coating and aluminum layer as a result of a heat treatment. The alumina applied in this way has a lower coefficient of expansion and in combination with the nickel (Ni) originating from the compressor abradables part of the aluminum oxide flakes off. The remaining layer then protects against the intrusion of liquid deposits.

The inventive step also lies in the application of the different particles sizes of the aluminum oxide, which firstly provides protection against Ni deposits but also against CMAS. Since the deposits of nickel (Ni) occur only briefly and at the beginning of the operating time, a layer which has a short-term action here and a layer having a long-term action against CMAS or similar attacks are present.

The layer of aluminum oxide spheres and optionally glass is in each case at least 20% thinner than the ceramic layer system 10.

The glass can be, in particular, silicon oxide, in particular SiO₂.

Instead of aluminum, it is also possible to use aluminum and zirconium (FIG. 3). Aluminum oxide having zirconium oxide inclusions and a reaction layer between thermal barrier coating and aluminum/zirconium layer are formed for the corrosion protection layer 16 by means of a heat treatment. Zirconium improves the adhesion of the protective layer to the thermal barrier coating. In addition, zirconium reduces the viscosity of the CMAS and prevents or slows the infiltration of the CMAS and thus increases the life of the layer system.

A glass layer as described above can also be and have been applied over the layer of aluminum oxide/zirconium oxide or over the metallic aluminum/zirconium.

The heat treatment to form aluminum oxide or aluminum oxide/zirconium oxide can be carried out by means of a first use of the component or by means of a preceding heat treatment before the first use or after it has been installed in a machine for high-temperature use.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A process for producing a ceramic layer system having an outer corrosion protection layer, wherein, at least on a substrate or a metallic bonding layer, applying at least one ceramic protective layer to the substrate or the metallic bonding layer and applying, a layer of aluminum particles to the ceramic protective layer, wherein only aluminum particles which form hollow aluminum oxide spheres are applied as a result of a heat treatment, and carrying out the heat treatment.

2. A component produced as claimed in claim 1, which comprises at least:
a substrate or a metallic bonding layer composed of a nickel- or cobalt-based superalloy, which is based on MCrAlY wherein M is selected from Ni, Co and Fe, a ceramic protective layer for thermal insulation, a corrosion protection layer which is thinner than the ceramic protective layer and at least hollow aluminum oxide spheres.

3. The process as claimed in claim 1, wherein the aluminum particles are applied by a slip, vapor deposition or sputtering.

4. The process or component as claimed in claim 1, wherein a mixture of aluminum particles and zirconium particles is or has been applied.

5. The process or component as claimed in claim 1, wherein the aluminum particles are a powder which has particle sizes of up to 50 μm.

6. The process or component as claimed in claim 4, wherein a low-melting, viscous glass is or has been applied to the aluminum layer, the aluminum/zirconium layer or the oxidized layers thereof is or has been applied by a slip.

7. The process or component as claimed in claim 6, wherein the low-melting, viscous glass comprises SiO₂.

8. The process or component as claimed in claim 6, wherein the low-melting, viscous glass comprises additives such as magnesium (Mg), calcium (Ca), boron (B) and/or sodium (Na).

9. The process or component as claimed in claim 6,
wherein silicon-containing precursors for the glass are or have been applied to the aluminum layer, the aluminum/zirconium layer or the oxidized layers, wherein the oxide layers are silazane, siloxane or silicone polymers.

10. The component as claimed in claim 2, wherein an outer glass layer is present on the layer of hollow aluminum oxide spheres.

11. The process or component as claimed in claim 1, wherein the corrosion protection layer is at least 30% thinner than the ceramic protective layer.

12. The component as claimed in claim 2, wherein the corrosion protection layer consists of aluminum oxide and zirconium oxide.

13. The process as claimed in claim 1, wherein the heat treatment is achieved by a first use of the component at high temperatures.

14. The process as claimed in claim 1, wherein the heat treatment is carried out before the first use of the component and/or installation of the component in a machine.

15. The process or component as claimed in claim 1, wherein the corrosion protection layer has a maximum thickness of 300 μm.
